(19) United States
(12) Patent Application Publication
(10) Pub. No.: US 2013/0271605 A1
(43) Pub. Date: Oct. 17, 2013

(54) Detection of the Use of Mobile Communication Devices in a Vehicle

(71) Applicant: Donna C. Winner, (US)

(72) Inventor: James E Winner, Jr., Sharon, PA (US)

(21) Appl. No.: 13/391,808

(22) PCT Filed: Aug. 23, 2010
(86) PCT No.: PCT/US10/46339

§ 371 Date: Oct. 3, 2012

Related U.S. Application Data
(60) Provisional application No. 61/236,364, filed on Aug. 24, 2009.

(30) Foreign Application Priority Data
Aug. 25, 2009 (US) PCTUS2010046339

(51) Int. Cl. B60Q 1/26; H04N 7/18

(52) U.S. Cl. CPC B60Q 1/26; H04N 7/188
USPC 348/148; 340/425.5

(57) ABSTRACT

The invention provides notification externally of a vehicle that the operator of the vehicle is using a mobile communication device (MCD) such as a cell phone during vehicle operations. The invention includes a first sensor for sensing whether the vehicle is being operated. A second sensor senses whether an MCD is located in the immediate vicinity of what is customarily an operator's seat and whether the sensed MCD is being used during vehicle operations. The first sensor can be a detector coupled with a gear shifter, transmission, speedometer, GPS device, or other kind of motion and/or position sensor, while the second sensor can be one or more RF power meters. Notification of MCD usage during vehicle operations can be provided by illumination of an external lamp, by activation of a camera and video recorder located in the immediate vicinity, or by transmission of a signal to a law enforcement vehicle.

### REFERENCE TO PROVISIONAL APPLICATION

The present application claims priority from, and incorporates by reference herein, U.S. provisional application Ser. No. 61/236,364, entitled Detection of the Use of Mobile Communication Devices in a Vehicle, filed Aug. 24, 2009 by James E. Winner, Jr.

### BACKGROUND OF THE INVENTION

1. Field of the Invention

The invention relates to the use of mobile communication devices in a vehicle and, more particularly, to a method and apparatus for indicating to a non-occupant of a vehicle whether or not a mobile communication device is being used by the operator of the vehicle while the vehicle is moving.

2. Description of the Prior Art

Mobile communication devices such as cell phones, two-way radios, and personal digital assistants have been widely used in the United States and other countries for many years. As used herein, the term “mobile communication device” includes a wireless telephone, a text-messaging device, a personal digital assistant, a computer, or any other substantially similar wireless device that is designed or used to communicate voice, text, or data. For convenience, all such devices will be referred to herein as “MCDs” or “MCD.”

MCDs, when used properly, can provide great benefit and convenience to their users. A significant benefit of such devices is the ability to communicate with third parties in the event of an accident or other emergency while driving. Unfortunately, the use of MCDs requires considerable attention to detail that may detract from the attention required to operate a vehicle safely and that may lead to accidents. The problem has become so widespread that many government jurisdictions have passed or are considering passing laws or ordinances against the use of MCDs in moving vehicles.

Laws and ordinances related to the use of MCDs vary from jurisdiction to jurisdiction in terms of what is prohibited and what exceptions, if any, will be permitted. A typical exception is to permit use of MCDs in moving vehicles by law enforcement officers during the course of their duties. Nevertheless, a common theme among these laws and ordinances is that they prohibit “texting” on a handheld or manually operated MCD during the course of operating a motor vehicle on streets, highways, or property open to vehicular traffic. Some go so far as to prohibit all non-emergency use of handheld or manually operated MCDs during the course of operating a motor vehicle.

A problem with any law or ordinance governing the use of MCDs is that of detecting whether MCDs are being used in a moving vehicle. The problem is particularly difficult since the use of MCDs in non-moving vehicles usually is not prohibited. One approach that has been taken is disclosed in U.S. Patent Application Publication 2009/0085728, the disclosure of which is incorporated herein by reference. In the '728 application, MCD activity data is received from a wireless network. User account data is searched using selected parameters from the MCD activity data to identify one or more subscribers that are or were using an MCD. One of more subscriber vehicles or vehicle monitoring systems associated with each of the one or more subscribers are identified. Vehicle operation data from one or more vehicle monitoring systems is received. The vehicle operation data is used to determine whether any of the one or more subscriber vehicles were moving during use of an associated MCD. A problem with the approach taken in the '728 application is that it does not provide direct evidence of MCD use in a moving vehicle by the operator of the vehicle.

Other approaches have been taken in an attempt to address the foregoing and related concerns. U.S. Patent Application Publication 2004/0077339 discloses a “jamming” device that blocks incoming and outgoing calls on a cell phone when a vehicle's gear selector is in a position other than “park.” U.S. Pat. No. 7,049,941 discloses a device that alerts the driver either audibly or visually that a cell phone call is being received and whether certain potentially dangerous driving conditions are present. The conditions can be ranked from low-risk to high-risk. U.S. Patent Application Publication 2007/0229234 discloses a wireless device that is designed to recognize when a cell phone is in use (or to recognize if the driver is falling asleep). The device activates an audible alarm and a series of flashing lights to draw the driver's attention to the dashboard. U.S. Patent Application Publication 2008/0064413 discloses a method for locating the location of a cell phone or PDA by transmitting the information from the cell phone or PDA to a remote facility. Once the information is sent, the remote facility can detect the location of the cell phone or PDA. International Application WO2005/109369 discloses a device that detects events in a vehicle, such as speeding, and that will issue an audible warning in the vehicle or will automatically end a cell phone call or both. The device also can be integrated with traffic light-controlled intersections in an attempt to prevent the driver from running a red light.

Additional publications of interest include U.S. Pat. No. 7,646,312/US2009/0275281, which discloses a mobile phone detection, enforcement, and interruption system. A detector is set up outside of a vehicle and is coupled with a camera/interruption system. U.S. Patent Application Publication 2009/0184819 discloses a method for detecting radio frequency signals. The device generates audible signals of different frequency according to signal strength. U.S. Pat. No. 6,222,458 and U.S. Pat. No. 6,580,372 disclose automatic cell phone detection at locations where combustible materials might be located, such as automobile service stations. A problem with this approach is that detection is involved for longer ranges. U.S. Pat. No. 6,771,946 disables a cell phone by use of a phase reversal transmitter.

Other approaches are known that relate to providing external notification of whether a vehicle's seatbelts are being used or are being used improperly. In U.S. Pat. No. 4,849,733, an external light is provided for a vehicle. The external light is colored blue or amber in order to distinguish it from the vehicle's operating lights. A switch is activated when the seatbelt is buckled and the external light is illuminated. Accordingly, an outside observer such as a law enforcement officer will be able to determine visually when the seatbelt is being used.

Another approach is disclosed in U.S. Pat. No. 7,005,976. In the '976 patent, various sensors such as an acceleration sensor, a buckle interlock, and other devices are used to determine not only that the seatbelt buckle is engaged, but also that the belt is properly positioned on the user. The '976 patent discloses a variety of control/warning features such as a speed governor, an ignition/transmission lock, and an external warning lamp that are operated by an interlock mechanism. If the interlock mechanism senses that the seatbelt is not fastened or is not being used properly, the lamp will notify non-occupants of that fact.

Other techniques are disclosed in U.S. Pat. Nos. 7,271,712; 7,446,652; and 6,942,248. In the '712 patent, if a seatbelt is not fastened or is not being used properly, a transmitter transmits an electromagnetic signal to an exterior device that provides exterior notification of that fact. In the '652 patent, if a seatbelt is not fastened or is not being used properly, an electromagnetic signal is transmitted to a monitor who can contact the driver concerning proper seatbelt usage. In the '248 patent, a signal is generated based on such factors as whether a child seat is in use, the orientation of the child seat, and so forth. A receiver receives the signal and generates a different signal which can be used for various purposes such as informing third parties of the occupancy status of the vehicle. In one instance, a signal will be sent to assistance personnel in the event of an accident.

Applicant incorporates the disclosures of each of the foregoing patents by reference herein. Despite the approaches taken by the referenced patents, certain concerns remain. More particularly, the most difficult problem is for law enforcement authorities to determine whenever an MCD is being used by the driver of a moving vehicle. The problem is particularly difficult due in part to MCD use by passengers and/or other people in close proximity to the vehicle operator. MCDs have different signal strengths that can exacerbate the problem of determining the position of signal sources. A problem with subscription or database-search based detection methods is that of drivers using MCDs not registered or subscribed under their names. Also, signals may be sent by “smart phones” automatically, which requires visual evidence to show that the vehicle operator is actively using his/her MCD.

As compared to seat belt usage detection where the circuitry operates in a contained environment and the lamp/signal indication can be made error-free, MCD use detection operates essentially in an uncontrolled environment that is subject to different kinds of noise, some of which are described above. While some cases may ultimately require external verification in the form of photographs of a vehicle operator to show whether or not they were using an MCD while operating the vehicle, the present invention represents an approach that is intended to be sufficiently accurate and reliable that external evidence of prohibited MCD usage generally will not be necessary.

### SUMMARY OF THE INVENTION

In response to the foregoing concerns, the present invention provides a new and improved method and apparatus especially adapted to provide notification externally of a vehicle that the operator of the vehicle is using an MCD while the vehicle is in motion or is otherwise being operated as may be defined by laws or ordinances. In a first embodiment of the invention, a vehicle includes an external lamp that is connected to the vehicle in a manner to detect if the vehicle is being operated. If the MCD is not being used by the operator during vehicle operations, the external lamp will be in a first state, e.g., not illuminated. If the MCD is being used by the operator during vehicle operations, the external lamp will change to a second state, e.g., illuminated continuously or blinking. The system therefore provides a positive indication to an observer that an MCD is being used by the vehicle operator while the vehicle is in motion.

In a second embodiment of the invention, a vehicle includes a transmitter that generates a signal if an MCD is being used by the vehicle operator during vehicle operations. The signal is transmitted to a receiver included as part of an external video recorder, e.g., a red light camera, radar-activated speed camera, or other specialty camera, that may be in the immediate vicinity. Upon receipt of such a signal, the video recorder will be activated and a visual image of the vehicle will be taken and recorded. As is conventional, the image will show the vehicle's license plate and a portion of the vehicle's interior where the driver and any front seat passengers are located. Since the driver and any front seat passengers will be in the image, the image will constitute visual evidence that an MCD was being used by the vehicle operator.

In a third embodiment of the invention, a vehicle includes a transmitter that generates a signal if an MCD is being used by the vehicle operator during vehicle operations. A law enforcement vehicle such as a police car includes a receiver adapted to receive the signal when the police car is in the vicinity of the vehicle. The police car includes an annunciator that is activated upon receipt of such a signal. The annunciator will notify the law enforcement officer driving the police car that a vehicle is being operated nearby in violation of the MCD-usage laws. Accordingly, the officer will be able to locate the vehicle and take appropriate enforcement action.

The invention includes a first sensor to detect whether or not the vehicle is moving or is otherwise being operated as may be defined by laws or ordinances (such as having the engine running and the transmission in gear). Such apparatus can include a detector coupled with a gear shifter, transmission, speedometer, GPS device, or other kind of motion and/or position sensor.

The invention also includes a second sensor in the form of MCD detection circuitry that employs one or more MCD signal detectors, which are basically radio frequency (RF) power meters that measure electromagnetic signals sent out by cell phones or other MCDs. Care must be taken when selecting and placing the RF meters so that they measure MCD frequency (800-2000 megahertz) and respond only to signals emitted from an MCD used by the vehicle operator. This requires that the RF meters be placed close to the driver seat and away from other passenger seats and only respond to signals from a cell phone or other MCD within very close proximity, no more than about two or three feet. Because different MCDs may have different signal strengths and because multiple MCDs and other RF sources may be in use, multiple RF meters (for example, three RF detectors for triangulation) may be needed. The power density of the RF meters may need to be analyzed to locate the positions of MCDs that are actively transmitting signals to ensure that detection occurs whenever an MCD is being used by the vehicle operator. The output of the MCD detection circuitry is used to activate the external lamp and/or transmitter(s) discussed previously. By using the vehicle operation detector in conjunction with the MCD usage detector and the external lamp and/or transmitters, it will be possible to determine externally of a vehicle whether the vehicle operator is using an MCD while the vehicle is in operation.

The foregoing and other features and advantages of the invention will be apparent from a review of the following description of the invention, taken together with the accompanying drawings.

### BRIEF DESCRIPTION OF THE DRAWINGS

FIG. 1 is a schematic view of a first embodiment of the invention;

FIG. 2 is a schematic view of a second embodiment of the invention;

FIG. 3 is a schematic view of a third embodiment of the invention; and

FIG. 4 is a flow chart that schematically illustrates the operation of the invention.

### DESCRIPTION OF THE PREFERRED EMBODIMENT

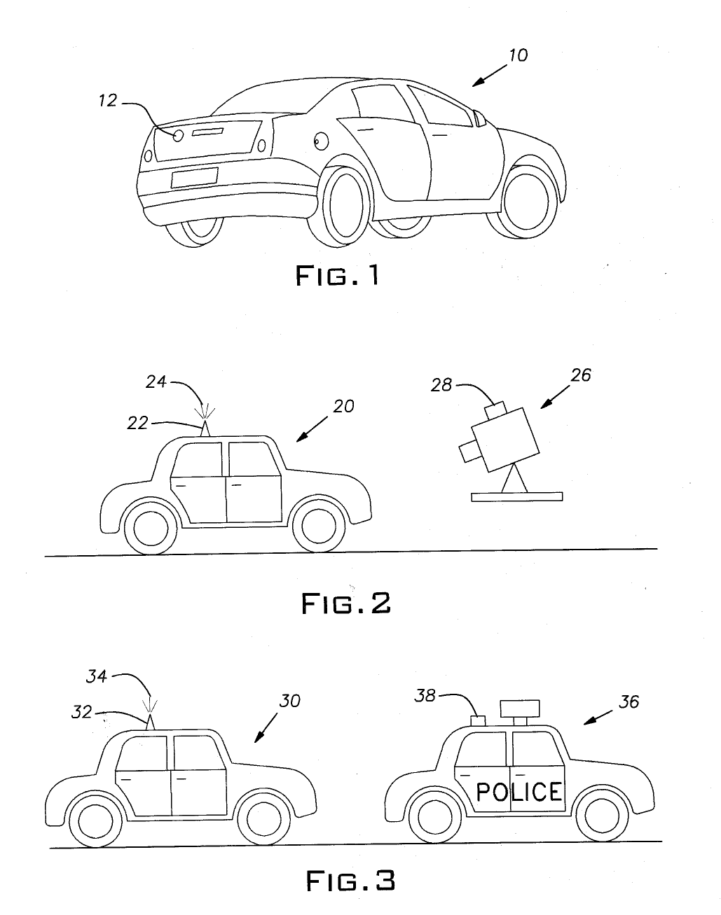

Referring to FIG. 1, a first embodiment of the invention is shown schematically. A vehicle 10 includes an external lamp 12. Preferably the lamp 12 is of a distinctive color such as blue or green that can be distinguished readily from conventional vehicle operating lights. Also, it is preferred that the lamp 12 be extremely reliable; for example, a light-emitting diode (LED) of suitable brightness may be used, if desired. The vehicle 10 includes a detector 14 that detects whether or not an MCD is being used. The detector 14 is connected to the vehicle's ignition system, gear selector and the external lamp 12. The vehicle 10 also includes an interlock (not shown) that restricts or prevents vehicle operation if the external lamp 12 or the detector 14 have been disabled.

If the detector 14 does not receive a signal that an MCD is being used while the gear selector is in a position other than “park” during vehicle operations, the external lamp 12 will be in a first state. Preferably, the first state is one in which the external lamp 12 is not illuminated. On the other hand, if the detector 14 detects that an MCD is in use while the gear selector is in any position other than “park” and the ignition switch is “on,” the detector 14 will cause the external lamp 12 to change to a second state. Preferably, the second state is one in which the external lamp 12 is be illuminated, either continuously or blinking. The system therefore provides a positive indication to an observer such as a law enforcement officer that an MCD is being used while the vehicle is being operated. It will be understood that the first and second states for the external lamp 12 can be chosen as desired in order to provide the greatest likelihood that an observer will be made aware that an MCD is being used while the vehicle is being operated.

Referring to FIG. 2, a second embodiment of the invention is shown schematically. A vehicle 20 includes a detector/transmitter 22 that detects radio frequency (RF) transmissions that occur when an MCD is used and generates a signal 24 if such usage is detected during vehicle operations. The signal 24 may be any type, such as infrared, laser, radio frequency, etc., that can be transmitted at least relatively short distances such as several hundred feet or more. Preferably, the signal 24 is an electromagnetic signal that is not line-of-sight.

A video recorder 26 in the nature of a red light camera, radar-activated speed camera, or other specialty camera includes a receiver 28. The receiver is adapted to receive the signal 24 that is being transmitted by a vehicle 20 that may be in the immediate vicinity. Upon receipt of such the signal 24, the video recorder will be activated and an image of the vehicle 20 will be created. Preferably, the image will be digitally recorded. Typically, the image will show the vehicle's license plate and a portion of the vehicle's interior where the driver and any front seat passengers are located. Since the driver and any front seat passengers will be in the image, the image will constitute visual evidence that the driver was using an MCD while the vehicle was in motion.

Referring to FIG. 3, a third embodiment of the invention is shown schematically. In this embodiment, a vehicle 30 includes a detector/transmitter 32 that detects radio frequency (RF) transmissions that occur when an MCD is used and generates a signal 34 if such usage is detected during vehicle operations. The signal 34 preferably is an electromagnetic signal (such as a radio signal). If it is economically feasible, the detector/transmitter 32 can be a transponder that receives an interrogating signal and that transmits a reply signal upon receipt of an interrogating signal.

A law enforcement vehicle such as a police car is indicated by the reference numeral 36. The police car 36 includes a receiver 38 that is adapted to receive the signal 34 that is being transmitted by a vehicle 30 that may be in the vicinity. Upon receipt of the signal 34, an annunciator such as an aural or visual alarm will be activated so that the officer driving the police car 36 will be notified that the vehicle 30 is being operated nearby in violation of the MCD-usage laws. Accordingly, the officer will be able to locate the vehicle 30 and take appropriate enforcement action.

If the detector/transmitter 32 is a transponder and the police car 36 has a corresponding transmitter (not shown) that sends a suitable interrogating signal, the task of locating the vehicle 30 will be quite easy. This is because the reply signal generated by the detector/transmitter 32 will provide specific information to the officer concerning the location of the vehicle 30.

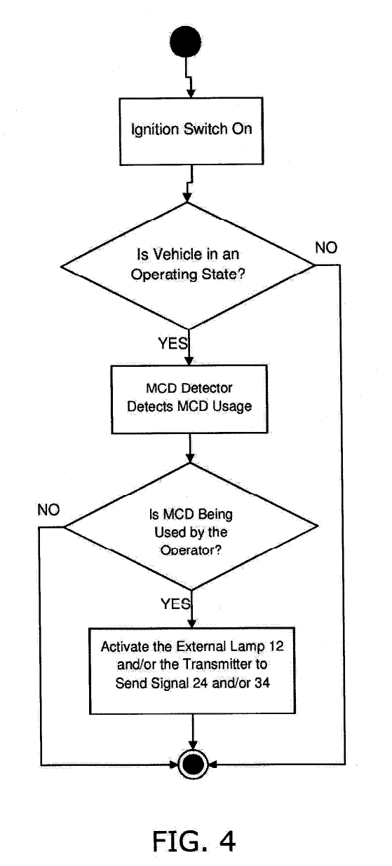

Referring to FIG. 4, a flow chart that illustrates schematically the operation of the invention is shown. The flow chart illustrates how the device may activate the external lamp 12, and/or the transmitter to send signal 24 and/or signal 34, using a first sensor to detect whether or not the vehicle is in an operating state, and a second sensor to detect whether or not an MCD is being used by the operator of the vehicle. A vehicle by definition is in an operating state when the vehicle is moving or is otherwise being operated in violation of laws or ordinances (such as by having the engine running with the transmission in gear).

In each of the described embodiments, steps can be taken to prevent the system from being overridden by the vehicle operator. For instance, an interlock such can be installed that will disable the vehicle 10 if the vehicle operator should disable or remove the lamp 12. Similarly, interlocks can be used to prevent vehicle operation if the detector/transmitter 22, 32 is disabled or removed.

The invention includes a first sensor to detect whether or not the vehicle is moving or is otherwise being operated in violation of laws or ordinances (such as by having the engine running with the transmission in gear). Such apparatus can include a detector coupled with a gear shifter, transmission, speedometer, GPS device, or other kind of motion and/or position sensor.

A second sensor is in the form of MCD detection circuitry that employs one or more MCD signal detectors, which are basically radio frequency (RF) power meters that measure electromagnetic signals sent out by cell phones or other MCDs. Care must be taken when selecting and placing the RF meters so that they measure MCD frequency (800-2000 megahertz) and respond only to signals emitted from an MCD used by the vehicle operator. This requires that the RF meters be placed close to the driver seat and away from other passenger seats and only respond to signals from a cell phone or other MCD within very close proximity, no more than about two or three feet. Because different MCDs may have different signal strengths and because multiple MCDs and other RF sources may be in use, multiple RF meters (for example, three RF detectors for triangulation) may be needed. The power density of the RF meters may need to be analyzed to locate the positions of MCDs that are actively transmitting signals to ensure that detection occurs whenever an MCD is being used by the vehicle operator. The output of the MCD detection circuitry is used to activate the external lamp and/or transmitter(s) discussed previously.

Suitable components that can be used for the detector 14 and the detector/transmitter 22, 32 can be found in the '728 patent application. Particular reference is made to monitoring system 101 with RF transmission sensor 113 and transceivers 115, 116, 117, 118, 119, and 120. For the actual engineering of such a device, experiments must be taken to measure the power density of different MCDs at different distances. Further, is must be determined how to control the gain and sensitivity of the RF detector(s) to restrict its detection range and to control the threshold output of the RF detector so that it would only respond signals generated within a short distance. Additionally, it must be determined how to deploy multiple (for example, three) RF detectors and read the outputs from the multiple RF detectors to determine if one or multiple MCDs are detected within the predetermined range and whether or not one of the MCDs falls into the driver location. Any experiments and calculations needed to make and use the invention are believed to be within the knowledge of a worker skilled in the art and further elaboration will not be made here.

By using the vehicle operation detector in conjunction with the MCD usage detector and the external lamp and/or transmitters, it will be possible to determine externally of a vehicle whether the vehicle operator is using an MCD while the vehicle is in operation. Therefore, by use of the invention, an external observer such as a law enforcement officer or an external device such as a video recorder will be able to quickly and easily determine whether or not a vehicle is being operated in violation of the MCD-usage laws.

Although the invention has been described in its preferred form with a certain degree of particularity, it will be understood that the present disclosure of the preferred embodiment has been made only by way of example and that various changes may be resorted to without departing from the true spirit and scope of the invention as hereinafter claimed. It is intended that the patent shall cover, by suitable expression in the appended claims, whatever features of patentable novelty exist in the invention disclosed.

What is claimed is:

1. Apparatus for indicating whether an operator of a vehicle is using a mobile communication device (MCD) during vehicle operations, comprising:
a first sensor for sensing whether the vehicle is being operated;
a second sensor for sensing whether an MCD is located in the immediate vicinity of what is customarily an operator's seat and whether the sensed MCD is being used during vehicle operations;
an indicator for indicating externally of the vehicle whenever the sensed MCD is being used during vehicle operations; and
an activator for activating the indicator whenever the sensed MCD is being used during vehicle operations.

2. The apparatus of claim 1, wherein:
the first sensor is a detector coupled with a gear shifter, transmission, speedometer, GPS device, or other kind of motion and/or position sensor;
the second sensor is one or more RF power meters;
the indicator is an external lamp carried by the vehicle that is electrically connected to the second sensor; and
the activator is circuitry for controlling illumination of the external lamp, the circuitry causing the external vehicle lamp to not be illuminated if the MCD is not being used by the vehicle operator during vehicle operations, and the circuitry causing the external vehicle lamp to be illuminated if the MCD is being used by the vehicle operator during vehicle operations.

3. The apparatus of claim 2, wherein the one or more RF power meters measure frequency in the approximate range of 800-2,000 MHz, are located no more than approximately two-three feet from the operator's seat, and are positioned to accomplish triangulation relative to an MCD located in the vicinity of the operator's seat.

4. The apparatus of claim 2, wherein the external lamp is a light-emitting diode of suitable brightness and is of a distinctive color different than that of conventional vehicle operating lights.

5. The apparatus of claim 2, wherein multiple external lamps are provided for different parts of the vehicle.

6. The apparatus of claim 2, further comprising means for preventing operation of the vehicle if any of the first sensor, the second sensor, the indicator, or the activator is disabled or removed.

7. The apparatus of claim 1, wherein the indicator and the activator include:
a transmitter carried by the vehicle that generates a signal if a sensed MCD is being used during vehicle operations;
a camera positioned such that it will capture images of a passing vehicle;
a video recorder electrically connected to the camera;
a receiver for receiving the signal generated by the transmitter, the receiver being in electrical communication with the camera;
circuitry for activating the camera upon receipt of a signal by the receiver; and
circuitry for activating the video recorder when the camera has been activated, whereby a visual image or a sequence of visual images of the vehicle will be taken and recorded.

8. The apparatus of claim 7, wherein the camera is a red light camera, radar-activated speed camera, or other specialty camera.

9. The apparatus of claim 7, further comprising an external lamp on the vehicle that is activated when a sensed MCD is being used during vehicle operations, the lamp being located on the vehicle so that images taken of the vehicle by the camera will show that the external lamp is illuminated.

10. The apparatus of claim 7, further comprising a license plate on the vehicle, the license plate being located on the vehicle so that images taken of the vehicle by the camera will show the license plate.

11. The apparatus of claim 7, further comprising an ambient lamp connected to the video recorder and directed toward passing vehicles, the ambient lamp being illuminated upon activation of the video recorder so as to illuminate the exterior and/or interior of a passing vehicle.

12. The apparatus of claim 7, wherein the signal generated by the transmitter includes information concerning vehicle identification, transmitter identification, MCD identification, MCD usage information, date and time of signal generation, and/or location of the vehicle and/or camera.

13. The apparatus of claim 12, wherein the information concerning vehicle identification, transmitter identification, MCD identification, MCD usage information, date and time of signal generation, and/or location of the vehicle and/or camera is recorded by the video recorder.

14. The apparatus of claim 1, wherein the indicator and the activator include:
a transmitter carried by the vehicle that generates a signal if a sensed MCD is being used during vehicle operations;
a receiver for receiving the signal generated by the transmitter, the receiver being located in a law enforcement vehicle;
an annunciator in the law enforcement vehicle, the annunciator being in electrical communication with the receiver; and
the annunciator being activated upon receipt of a signal by the receiver, whereby a law enforcement officer in the law enforcement vehicle will be notified that a vehicle is being operated nearby in violation of the MCD-usage laws.

15. The apparatus of claim 14, further comprising:
an external lamp carried by the vehicle that is electrically connected to the second sensor; and
circuitry for controlling illumination of the external lamp, the circuitry causing the external lamp to not be illuminated if the sensed MCD is not being used during vehicle operations, and the circuitry causing the external lamp to be illuminated if the sensed MCD is being used during vehicle operations.

16. The apparatus of claim 14, further comprising a transmitter in the law enforcement vehicle, wherein:
the transmitter carried by the vehicle is a transponder;
the transmitter in the law enforcement vehicle is capable of sending an interrogating signal to the transponder carried by the vehicle; and
the receiver in the law enforcement vehicle is capable of receiving a reply signal from the transponder, the receiver in the law enforcement vehicle providing information to the law enforcement officer concerning the location of the vehicle.

17. A method for indicating whether an operator of a vehicle is using a mobile communication device (MCD) during vehicle operations, comprising the steps of:
sensing whether the vehicle is being operated;
sensing whether an MCD is located in the immediate vicinity of what is customarily an operator's seat and whether the sensed MCD is being used during vehicle operations;
providing an indicator that indicates externally of the vehicle whenever the sensed MCD is being used during vehicle operations; and
activating the indicator whenever the sensed MCD is being used during vehicle operations.

18. The method of claim 17, wherein the step of sensing whether the vehicle is being operated is accomplished by providing a detector coupled with a gear shifter, transmission, speedometer, GPS device, or other kind of motion and/or position sensor, the step of sensing whether an MCD is located in the immediate vicinity of what is customarily an operator's seat and whether the sensed MCD is being used during vehicle operations is accomplished by providing one or more RF power meters, the step of providing an indicator is accomplished by providing an external lamp carried by the vehicle that is electrically connected to the one or more RF power meters, and the step of activating the indicator is accomplished by providing circuitry for controlling illumination of the external lamp, the circuitry causing the external vehicle lamp to not be illuminated if the sensed MCD is not being used during vehicle operations, and the circuitry causing the external vehicle lamp to be illuminated if the sensed MCD is being used during vehicle operations.

19. The method of claim 17, wherein the steps of providing an indicator and activating the indicator are accomplished by providing:
a transmitter carried by the vehicle that generates a signal if an MCD is being used during vehicle operations;
a camera positioned such that it will capture images of a passing vehicle;
a video recorder electrically connected to the camera;
a receiver for receiving the signal generated by the transmitter, the receiver being in electrical communication with the camera;
circuitry for activating the camera upon receipt of a signal by the receiver; and
circuitry for activating the video recorder when the camera has been activated, whereby a visual image or a sequence of visual images of the vehicle will be taken and recorded.

20. The method of claim 17, wherein the steps of providing an indicator and activating the indicator are accomplished by providing:
a transmitter carried by the vehicle that generates a signal if an MCD is being used during vehicle operations;
a receiver for receiving the signal generated by the transmitter, the receiver being located in a law enforcement vehicle;
an annunciator in the law enforcement vehicle, the annunciator being in electrical communication with the receiver; and
the annunciator being activated upon receipt of a signal by the receiver, whereby a law enforcement officer in the law enforcement vehicle will be notified that a vehicle is being operated nearby in violation of the MCD-usage laws.
